(19) United States
(12) Patent Application Publication
(10) Pub. No.: US 2008/0318081 A1
(43) Pub. Date: Dec. 25, 2008

(54) Malleable, High Mechanical Strength Aluminum Alloy Which Can be Anodized in a Decorative Manner, Method for Producing the Same and Aluminum Product Based on Said Alloy

(76) Inventor: Reiner Steins, Monheim (DE)

Correspondence Address: FRIEDRICH KUEFFNER, 317 MADISON AVENUE, SUITE 910, NEW YORK, NY, 10017, US

(21) Appl. No.: 11/579,520

(22) PCT Filed: Apr. 30, 2005
(86) PCT No.: PCT/EP2005/004721

§ 371 Date: Nov. 3, 2006

(30) Foreign Application Priority Data
May 8, 2004 (DE) 10 2004 022 817.5

(51) Int. Cl. B32B 15/20; C22C 21/02; C23C 8/02; C25D 11/16; C22F 1/043

(52) U.S. Cl. 428/640; 420/532; 420/535; 148/523; 205/206; 205/81; 148/281

(57) ABSTRACT

The invention relates to a malleable, high mechanical strength aluminum alloy of the AlMgSi type which can be anodized in a decorative manner, to a semifinished product produced from said alloy, in the shape of strips, sheets or extruded profiles, and to a structural component produced from the above semifinished products, especially a reshaped component that has been anodized in a decorative manner. The invention also relates to a method for producing an aluminum alloy component of the above type. Said aluminum alloy has good malleability, achieved by weight percentages of strontium in the alloy and defined weight ratios of silicon to magnesium and iron to strontium.

The invention concerns an aluminum alloy of the type AlMgSi which can be decoratively anodized, is highly ductile, and has high mechanical strength, a semifinished product made of this alloy in the form of strips, sheets, or extruded sections, and a decoratively anodized structural member produced from semifinished products of this type, especially one which has been formed. The invention also concerns a method for producing an aluminum alloy of this type.

Decoratively anodized structural members made of aluminum sheet are generally produced with unalloyed aluminum (1xxx alloys), AlMg alloys (5xxx alloys), or plated systems of the type 8xxx alloy with unalloyed aluminum (1xxx alloy) plating. None of these classes of materials can be age-hardened, i.e., strength is increased exclusively by cold working, which is then followed by removal of the work hardening by heat treatment. It follows that all of these systems have in common that their deformability and their state of strength are determined by the state of the semifinished products at delivery, which, for example, can either be work-hardened by rolling or softened by a subsequent removal of work hardening by heat treatment. It is thus possible for the sake of good deformability, to use these systems in a state of maximum removal of work hardening by heat treatment and then to form them. However, after the deformation process, age hardening to improve the useful properties of the material is no longer possible. For the sake of good useful properties, the systems can be used in a state of high strength, but then the deformability for a forming step is greatly limited due to the high initial strength of the material in its delivered state.

AlMgSi alloys (6xxx) that can be artificially aged and have good deformability are known, for example, from EP 0 714 993 and EP 0 811 700. The disclosed AlMgSi alloys are also used to produce strips and sheets. Due to their good deep-drawing property, they are also suitable for producing autobody sheet for the automobile industry. The alloy composition disclosed there results in an optimum between good strength and good deformation behavior. However, these alloys cannot be decoratively anodized, and above all they cannot be given a high luster in this way, since, for one thing, the iron content of 0.25 to 0.55 wt. % disclosed in EP 0 811 700 is too high and leads to clouding of the eloxal coating. It is well known that the intermetallic quaternary FeSiMgMn phases formed by the iron become incorporated in the eloxal coating. The coarse particles in the eloxal coating cause light scattering, which the observer perceives as cloudiness. A sufficiently transparent eloxal coating also cannot be realized at vanadium contents on the order of 0.05 to 0.4 wt. % which are specified in EP 0 714 993. In addition, vanadium at relatively high concentrations dissolves in the melt with difficulty. The replacement of vanadium by other recrystallization inhibitors, such as zirconium or chromium, also fails to produce the desired result. Chromium and zirconium result in an eloxal coating that is perceived to have a yellowish tinge after polishing or electropolishing.

Therefore, a well-known Al-99.9 MgSi alloy (6401 special) for extruded sections, which is used by the applicant for decorative structural members, contains no zirconium, vanadium, or chromium. Likewise, the contamination of the Al—Mg—Si alloy with iron is limited to 0.04 wt. % iron. This ensures that the aforementioned eloxal defects are avoided and a high degree of luster of the polished and electropolished structural member is achieved. However, due to the absence of recrystallization inhibitors (Fe, Zr, Cr, V), an alloy of this type does not exhibit optimum deformability, since the relatively coarse grain soon causes necking and orange peel formation.

It follows that, when an alloy composition is being selected for an extruded or rolled product, a compromise must be struck with respect to the deformability, the decorative appearance, and the mechanical strength, which manifests itself in final strength, ductility, and toughness.

The objective of the invention is to make available an aluminum alloy for structural members which have good deformation properties, have sufficient strength and ductility in the state in which they will be used, and can be decoratively anodized.

This objective is achieved with an aluminum alloy with the composition and features specified in claim 1. The optimum properties with respect to mechanical strength and deformation behavior are achieved, first of all, by a silicon content of 0.3 to 0.9 wt. % and a magnesium content of 0.1 to 0.5 wt. %, with the ratio by weight of these two constituents being adjusted in such a way that an excess of silicon over magnesium is present, especially a silicon-magnesium ratio by weight of 1.8 to 3.3. The strength is enhanced by a copper content of 0.1 to 0.4 wt. %, which causes solid solution hardening. Good deformability is guaranteed by the content of recrystallization inhibitors (iron, zirconium, chromium, vanadium). Iron is often present as an impurity in a parent alloy. However, it can also be added as an alloying component up to a content of 0.2 wt. %. Zirconium, chromium, and vanadium can be present in the alloy individually or together up to a content 0.22 wt. %. Despite the presence of the aforementioned recrystallization inhibitors, the alloy of the invention can be decoratively anodized and shows no yellowish or cloudy eloxal coating. This is the result of the strontium content of 0.005 to 0.1 wt. %. It is assumed that the strontium alters the iron-, zirconium-, chromium-, and/or vanadium-containing phases, in particular, that it renders them less coarse to the extent that they do not cause visible clouding even when they are incorporated in the eloxal coating. The surprising finding was made that a ratio by weight of iron to strontium of 3:1 to 5:1 is especially advantageous.

An alloy of this type is produced from an aluminum parent material with more than 99.85 wt. % aluminum. The alloying components are added to the melt as follows: 0.3 to 0.9 wt. % silicon, 0.1 to 0.5 wt. % magnesium, with the ratio by weight of silicon to magnesium being 1.8:1 to 3.3:1. Since iron can be present as an impurity in the aluminum parent material, the iron content of the parent material is determined. If necessary, additional iron is added as an alloying component, so that the alloy to be produced contains up to 0.2 wt. % iron. In addition, strontium is added in amounts of 0.005 to 0.1 wt. %, and the ratio by weight of iron to strontium is adjusted within the range of 3:1 to 5:1. The addition of 0.008 to 0.07 wt. % strontium is preferred. The following additional alloying components are added: 0.1 to 0.4 wt. % copper, 0.03 to 0.2 wt. % manganese, 0.01 wt. % titanium, and total amounts of 0.08 to 0.22 wt. % zirconium and/or chromium and/or vanadium. The alloy should contain a maximum of 0.04 wt. % zinc, and unavoidable impurities should be present in maximum amounts of 0.02 wt. % each with a total combined maximum amount of 0.15 wt. %. In addition, a specific fraction of silver can be added for alloy identification, namely, 0.0005 to 0.005 wt. %.

The melt produced in this way is continuously cast to form a rolling billet or a continuously cast billet and then homogenized (annealing for at least 2 h at at least 500° C.). Pure aluminum containing at least 99.85 wt. % aluminum is preferably used as the aluminum parent material in order to limit the percentage of impurities. A content of unavoidable impurities of a maximum of 0.15 wt. % should not be exceeded. The alloying components can be added in the form of pure metals or master alloys. The strontium is preferably added in the form of an aluminum-strontium master alloy, especially an AlSr3.5 master alloy, an AlSr5 master alloy, or an AlSr10 master alloy.

Open or hollow chamber extruded sections can be obtained from the homogenized continuously cast billets of the aluminum alloy of the invention by extrusion. They are usually stretched and fabricated by sawing. Three-dimensionally shaped unfinished structural members can be produced from the section pieces that have been cut to the desired length by subsequent forming processes, especially cold forming processes, such as rolling, bending, deep drawing, or sheet-metal forming or tube forming based on active means. Regardless of whether the forming involves a bending process, a forming process based on active means, or deep drawing, the resulting structural member has good contour accuracy due to low springback and at the same time shows low orange peel formation. The strength and ductility can be adjusted after the forming operation due to the age-hardenability of the alloy. After age hardening, the structural member is subjected especially to chemical and electrolytic treatment and possibly machining operations. The chemical and electrolytic treatments include polishing, finish-polishing, anodizing, possibly coloring, and a final compression of the structural members. The resulting eloxal coating of the decoratively anodized, shaped aluminum structural member is very satisfactory; it is transparent, i.e., it does not have a cloudy appearance or a yellowish tinge.

Sheet bars can be produced from the rolling billets by hot rolling. They can be further processed by cold rolling and process annealing. An unfinished structural member is formed by additional forming steps (possibly recrystallization annealing and/or removal of work hardening by heat treatment), such as deep drawing, sheet-metal forming based on active means, including patterning, smoothing or roughening of the surfaces, and possibly another soft annealing, and possibly machining operations. This unfinished structural member can also be subsequently provided with a decorative eloxal coating by chemical or electrolytic treatment. In this production process as well, it can be demonstrated that the aluminum alloy shows good to very good deformation behavior at room temperature with only slight orange peel formation, has stable deformation behavior, and leads to very good contour accuracy of the structural member. The eloxal coating has no defects. On the contrary, it is even possible to realize lustrous surfaces if pure aluminum containing at least 99.9 wt. % aluminum is used as the parent material.

Specific embodiments of aluminum alloys of the invention are given below in three tables. Table 1 shows high-strength AlMgSi alloys, Table 2 intermediate-strength AlMgSi alloys, and Table 3 low-strength AlMgSi alloys. Table 4 shows well-known alloys for purposes of comparison, including the applicant's own alloy AA6401 special, an intermediate-strength AlMgSi alloy, which has been used until now for decorative applications but does not exhibit optimum deformation behavior. The other comparative alloys exhibit optimum strength and deformation behavior but cannot be decoratively anodized.

The following chart provides an overview of the various process variants for producing a decoratively anodized, formed aluminum structural member:

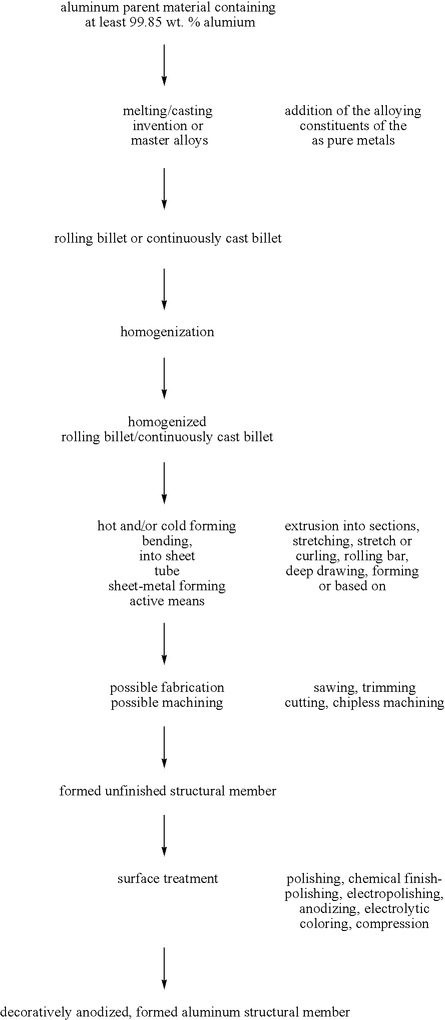

An aluminum structural member was produced by one of these process variants from an alloy of the invention by continuous casting, homogenization, extrusion, stretching, cutting to length, deep drawing, polishing, finish-polishing, and anodizing. For comparison, structural members formed in the same way by the same method were produced from a 6401 alloy and a 6016 alloy. The properties of the structural members are shown in Table 5. The imaging sharpness in different areas of the surface of the finished structural members was measured as an indication of the surface properties. High imaging sharpness is an expression of high luster and high imaging accuracy, i.e., whether lines are represented straight or distorted. The deformability was entered as effective strain. A measuring screen was applied beforehand on flat pieces of extruded section of the various alloys, and the degree of deformation was determined from the changed line screen after a process similar to deep drawing. It is clear that the structural member of the invention is the only structural member with both good imaging sharpness (80%) and good deformability (40%).

TABLE 1
HIGH-STRENGTH AlMgSi

| | | Weight-% | | | | | | | | | | |
|---|---|---|---|---|---|---|---|---|---|---|---|---|
| | | | | | | | | | | | Permissible | Permissible |
| | | | | | | | | | Add. | Add. | impurities, | impurities, |
| Designation | Si/Mg | Si | Fe | Cu | Mn | Mg | Cr | Ti | 1 | 2 | each | total |
| A | 2 | 0.8 | 0.2 | 0.4 | 0.2 | 0.4 | 0.2 | 0.010 | Zr | Sr | 0.02 | 0.15 |
| | | | | | | | | | 0.1 | 0.04 | | |
| B | 3 | 0.9 | 0.2 | 0.4 | 0.2 | 0.3 | 0.2 | 0.010 | Zr | Sr | 0.02 | 0.15 |
| | | | | | | | | | 0.1 | 0.04 | | |
| C | 2 | 0.8 | 0.040 | 0.10 | 0.03 | 0.4 | — | 0.010 | Zr | Sr | 0.02 | 0.15 |
| | | | | to | | | | | 0.1 | 0.01 | | |
| | | | | 0.15 | | | | | | | | |
| D | 3 | 0.9 | 0.040 | 0.10 | 0.03 | 0.3 | — | 0.010 | Zr | Sr | 0.02 | 0.15 |
| | | | | to | | | | | 0.1 | 0.01 | | |
| | | | | 0.15 | | | | | | | | |

TABLE 2
INTERMEDIATE-STRENGTH AlMgSi

| | | Weight-% | | | | | | | | | | |
|---|---|---|---|---|---|---|---|---|---|---|---|---|
| | | | | | | | | | | | Permissible | Permissible |
| | | | | | | | | | Add. | Add. | impurities, | impurities, |
| Designation | Si/Mg | Si | Fe | Cu | Mn | Mg | Cr | Ti | 1 | 2 | each | total |
| E | 2 | 0.5 | 0.2 | 0.4 | 0.2 | 0.25 | 0.2 | 0.010 | Zr | Sr | 0.02 | 0.15 |
| | | | | | | | | | 0.1 | 0.04 | | |
| F | 3 | 0.6 | 0.2 | 0.4 | 0.2 | 0.2 | 0.2 | 0.010 | Zr | Sr | 0.02 | 0.15 |
| | | | | | | | | | 0.1 | 0.04 | | |
| G | 2 | 0.5 | 0.040 | 0.10 | 0.03 | 0.25 | — | 0.010 | Zr | Sr | 0.02 | 0.15 |
| | | | | to | | | | | 0.1 | 0.01 | | |
| | | | | 0.15 | | | | | | | | |
| H | 3 | 0.6 | 0.040 | 0.10 | 0.03 | 0.2 | — | 0.010 | Zr | Sr | 0.02 | 0.15 |
| | | | | to | | | | | 0.1 | 0.01 | | |
| | | | | 0.15 | | | | | | | | |

TABLE 3
LOW-STRENGTH AlMgSi

| | | Weight-% | | | | | | | | | | |
|---|---|---|---|---|---|---|---|---|---|---|---|---|
| | | | | | | | | | | | Permissible | Permissible |
| | | | | | | | | | Add. | Add. | impurities, | impurities, |
| Designation | Si/Mg | Si | Fe | Cu | Mn | Mg | Cr | Ti | 1 | 2 | each | total |
| I | 2 | 0.3 | 0.2 | 0.4 | 0.2 | 0.15 | 0.2 | 0.010 | Zr | Sr | 0.02 | 0.15 |
| | | | | | | | | | 0.1 | 0.04 | | |
| K | 3 | 0.4 | 0.2 | 0.4 | 0.2 | 0.13 | 0.2 | 0.010 | Zr | Sr | 0.02 | 0.15 |
| | | | | | | | | | 0.1 | 0.04 | | |
| L | 2 | 0.3 | 0.040 | 0.10 | 0.03 | 0.15 | — | 0.010 | Zr | Sr | 0.02 | 0.15 |
| | | | | to | | | | | 0.1 | 0.01 | | |
| | | | | 0.15 | | | | | | | | |
| M | 3 | 0.4 | 0.040 | 0.10 | 0.03 | 0.13 | — | 0.010 | Zr | Sr | 0.02 | 0.15 |
| | | | | to | | | | | 0.1 | 0.01 | | |
| | | | | 0.15 | | | | | | | | |

TABLE 4
COMPARATIVE ALLOYS

| | | Weight-% | | | | | | | | | | | |
|---|---|---|---|---|---|---|---|---|---|---|---|---|---|
| | | | | | | | | | | | | Permissible | Permissible |
| | | | | | | | | | | Add. | Add. | impurities, | impurities, |
| Designation | Si/Mg | Si | Fe | Cu | Mn | Mg | Cr | Zn | Ti | 1 | 2 | each | total |
| AA6401 | 0.9 to 1.25 | 0.4 | 0.04 | 0.10 | 0.03 | 0.35 | — | 0.04 | 0.01 | — | — | <0.01 | <0.10 |
| special | | to | | to | | to | | | | | | | |
| | | 0.5 | | 0.15 | | 0.45 | | | | | | | |
| AA6016 | 6 to 1.7 | 1.0 | 0.50 | 0.20 | 0.20 | 0.25 | 0.10 | 0.20 | 0.15 | — | — | <0.05 | <0.15 |
| | | to | | | | to | | | | | | | |
| | | 1.5 | | | | 0.6 | | | | | | | |
| AA6014 V | 1.5 to 0.4 | 0.3 | 0.35 | 0.25 | 0.05 | 0.40 | 0.20 | 0.1 | 0.10 | V 0.25- | — | <0.05 | <0.15 |
| | | to | | | to | to | | | | 0.20 | | | |
| | | 0.6 | | | 0.20 | 0.80 | | | | | | | |
| AA6082 | 2.2 to 0.6 | 0.7 | <0.5 | <0.1 | 0.4 | 0.6 | <0.25 | <0.20 | 0.10 | — | — | <0.05 | <0.15 |
| | | to | | | to | to | | | | | | | |
| | | 1.3 | | | 1.0 | 1.2 | | | | | | | |
| AA6111 | 2.2 to 0.6 | 0.6 | 0.40 | 0.50 | 1.10 | 0.5 | 0.10 | 0.15 | 0.10 | — | — | <0.05 | <0.15 |
| | | to | | to | to | to | | | | | | | |
| | | 1.1 | | 0.9 | 0.45 | 1.0 | | | | | | | |
| AA6022 | 7.5 to 1.1 | 0.8 | 0.05 | 0.02 | 0.02 | 0.2 | 0.1 | 0.25 | 0.15 | — | — | <0.05 | <0.15 |
| | | to | to | to | to | to | | | | | | | |
| | | 1.5 | 0.20 | 0.1 | 0.10 | 0.7 | | | | | | | |

TABLE 5
PROPERTIES OF THE VARIOUS ALUMINUM STRUCTURAL
MEMBERS

| Material of the aluminum | Imaging | Degree of |
|---|---|---|
| structural member | sharpness | deformation |
| 6401 | 80% | maximum 20% |
| 6016 | 30% | maximum 45% |
| aluminum alloy of the | 80% | maximum 40% |
| invention | | |

1. Highly ductile aluminum alloy with high mechanical strength which can be decoratively anodized, with the following composition:
0.3 to 0.9 wt. % silicon,
0.1 to 0.5 wt. % magnesium,
up to 0.2 wt. % iron,
0.1 to 0.4 wt. % copper
0.03 to 0.2 wt. % manganese
0.01 wt. % titanium,
0.08 to 0.22 wt. % zirconium and/or chromium and/or vanadium, total
0.005 to 0.1 wt. % strontium,
maximum 0.04 wt. % zinc,
no or maximum 0.005 wt. % silver,
maximum 0.02 wt. % unavoidable impurities, each,
maximum 0.15 wt. % unavoidable impurities, total,
the remainder consisting of aluminum,
wherein the ratio by weight of silicon to magnesium is 1.8:1 to 3.3:1, wherein the ratio by weight of iron to strontium is 3:1 to 5:1.

2. Aluminum alloy in accordance with claim 1, wherein strontium is present in amounts of 0.008 to 0.07 wt. %.

3. Aluminum alloy in accordance with claim 1, wherein silver is present in amounts of 0.0005 to 0.005 wt. % for alloy identification.

4. Method for producing a decoratively anodized, formed structural member from an aluminum alloy, comprising the following process steps:
melting an aluminum parent material with more than 99.7 wt. % aluminum and addition of alloying components to the aluminum melt up to a total composition of:
0.3 to 0.9 wt. % silicon,
0.1 to 0.5 wt. % magnesium,
wherein the ratio by weight of silicon to magnesium is 1.8:1 to 3.3:1,
up to 0.2 wt. % iron,
0.005 to 0.1 wt. % strontium,
wherein the ratio by weight of iron to strontium is 3:1 to 5:1,
0.1 to 0.4 wt. % copper
0.03 to 0.2 wt. % manganese
0.01 wt. % titanium,
0.08 to 0.22 wt. % zirconium and/or chromium and/or vanadium, total
maximum 0.04 wt. % zinc,
maximum 0.02 wt. % unavoidable impurities, each,
maximum 0.15 wt. % unavoidable impurities, total, the remainder consisting of aluminum,
casting the aluminum alloy melt into a rolling billet or continuously cast billet,
homogenizing the rolling billet or continuously cast billet,
hot forming and, if necessary, cold forming to a formed unfinished structural member, and
chemical and/or electrolytic surface treatment of the formed unfinished structural member, comprising an anodic oxidation.

5. Method in accordance with claim 4, wherein the iron content of the aluminum parent material that is used is determined, and the desired ratio by weight of iron to strontium is adjusted by addition of strontium and additional iron.

6. Method in accordance with claim 4, wherein the aluminum parent material is pure aluminum that contains at least 99.9 wt. % aluminum.

7. Method in accordance with claim 4, wherein the strontium is added in the form of an aluminum-strontium master alloy.

8. Method in accordance with claim 7, wherein the strontium is added in the form of an AlSr5 master alloy, an AlSr10 master alloy, or an AlSr3.5 master alloy.

9. Method in accordance with claim 4, wherein the homogenized rolling billet is hot formed into a sheet bar by hot rolling.

10. Method in accordance with claim 9, wherein the sheet bar is cold rolled to the desired final thickness with possible process annealing and, after a possible recrystallization annealing and/or removal of work hardening by heat treatment, the surface is patterned, smoothed, or roughened, and then the product is possibly subjected to another soft annealing and then cut to the desired lengths of sheet.

11. Method in accordance with claim 4, wherein the homogenized continuously cast billet is hot formed into an open or hollow chamber section by extrusion, stretched, and cut into section lengths.

12. Method in accordance with claim 10, wherein the lengths of section or lengths of sheet are cold formed in one or more additional steps, especially by rolling, bending, deep drawing, or tube forming or sheet-metal forming based on active means.

13. Method in accordance with claim 4, wherein formed unfinished structural members are polished, finish-polished, anodically oxidized (anodized), and compressed.

14. Method in accordance with claim 13, wherein an electrolytic coloring step is additionally performed.

15. Aluminum product made of an aluminum alloy with a composition in accordance with claim 1.

16. Aluminum product in accordance with claim 15, wherein the aluminum product is a strip, a sheet, an extruded section, or a formed structural member produced from the aforementioned semifinished products.

17. Aluminum product in accordance with claim 16, wherein the aluminum product is a decoratively anodized, formed structural member.
